(19) United States
(12) Patent Application Publication
(10) Pub. No.: US 2018/0281626 A1
(43) Pub. Date: Oct. 4, 2018

(54) VEHICLE SEAT CONTROL DEVICE, VEHICLE SEAT CONTROL METHOD, AND STORAGE MEDIUM

(71) Applicant: HONDA MOTOR CO., LTD., Tokyo (JP)

(72) Inventors: Masakuni Murakami, Wako-shi (JP); Hiroshi Akaba, Wako-shi (JP); Yasuhiro Minakawa, Wako-shi (JP)

(21) Appl. No.: 15/937,918

(22) Filed: Mar. 28, 2018

(30) Foreign Application Priority Data
Apr. 3, 2017 (JP) 2017-073951

(51) Int. Cl. B60N 2/02; B60N 2/427; B60R 21/0134; B60R 21/015

(52) U.S. Cl. CPC B60N 2/0276; B60N 2/42736; B60R 21/01554; B60R 21/0134; B60N 2/42745

(57) ABSTRACT

Provided is a vehicle seat control device which includes a collision prediction unit (50) which predicts whether a collision will occur in a vehicle and a time before the collision will occur, driving units (14a and 18a), each changing at least one of a position and a posture of a vehicle seat (10), and a control unit (80) which controls the driving units to bring the vehicle seat close to a target state during the time before the collision predicted by the collision prediction unit occurs.

### CROSS-REFERENCE TO RELATED APPLICATION

Priority is claimed on Japanese Patent Application No. 2017-073951, filed Apr. 3, 2017, the content of which is incorporated herein by reference.

### BACKGROUND

### Field of the Invention

The present invention relates to a vehicle seat control device, a vehicle seat control method, and a storage medium.

### Description of Related Art

As a device for protecting an occupant seated on a vehicle seat, there are a seat belt, an airbag, and the like. Japanese Unexamined Patent Application, First Publication No. 2017-30636 discloses a technology of adjusting a position and posture of a front seat to perform protection with an airbag for an occupant of a back seat in a case that a collision occurs in a state in which a position of a front seat on which a rear airbag is provided on a back side of the seat has changed.

### SUMMARY

However, in this conventional technology, performing optimum posture control of a vehicle seat in a leeway time before a collision occurs is not taken into account.

The present invention has been made in consideration of the above-described circumstances, and it is an object of the present invention to provide a vehicle seat control device, a vehicle seat control method, and a storage medium with which a posture of a vehicle seat is able to be optimally controlled in a leeway time before a collision occurs.

A vehicle seat control device, a vehicle seat control method, and a storage medium according to the present invention employ the following configuration.

(1) A vehicle seat control device according to one aspect of the present invention includes a collision prediction unit which predicts whether a collision will occur in a vehicle and a time before the collision will occur, a driving unit which changes at least one of a position and a posture of a vehicle seat, and a control unit which controls the driving unit such that the vehicle seat is brought close to a target state during the time before the collision predicted by the collision prediction unit occurs.

(2) In the above aspect (1), the target state may be a state in which a position of the vehicle seat in a front-rear direction of the vehicle is within a predetermined range and a reclining angle is within a predetermined angular range used during manual control.

(3) In the above aspect (1), the target state may be a state of the vehicle seat in which a head of an occupant is in an effective area for an airbag.

(4) In the above aspect (1), the target state may be a state of the vehicle seat having a posture in which an occupant has a posture allowing effective protection by a seat belt.

(5) In the above aspect (1), the collision prediction unit may predict a time before the collision with respect to an object will occur on the basis of a relative distance between the vehicle and the object and a relative speed between the vehicle and the object.

(6) In the above aspect (1), a collision detection unit which detects a collision may be further provided, in which the control unit stops controlling the driving unit in a case that a collision is detected by the collision detection unit.

(7) In the above aspect (1), a seating position detection unit which detects a seating position of an occupant relative to a backrest portion may be further provided, in which the control unit moves the vehicle seat to an effective area for an airbag on the basis of the seating position detected by the seating position detection unit.

(8) A seat control method using an in-vehicle computer, comprising, predicting whether a collision will occur in a vehicle and a time before the collision will occur, changing a position or a posture of the vehicle seat, and bringing the vehicle seat close to a target state during the time before the predicted collision occurs.

(9) A non-transitory computer-readable recording medium recording a seat control program causing an in-vehicle computer to predict whether a collision will occur in a vehicle and a time before the collision will occur, change a position or a posture of a vehicle seat, and bring the vehicle seat close to a target state during the time before the predicted collision occurs.

According to the above aspects (1) to (4), (8), and (9), even in a case that the occupant has changed a position of the vehicle seat or a reclining angle, in a case that a collision is predicted, it is possible to protect the occupant by causing the vehicle seat to be brought into a state in which an occupant protection device effectively works during the time before the collision occurs.

According to the aspect (5) described above, it is possible to predict a time before a collision will occur.

According to the aspect of (6) described above, an electrical load can be prevented from becoming overloaded even in a case that a collision occurs during the predicted time before a collision occurs.

According to the aspect (7) described above, a protection performance for the occupant can be further enhanced by reconciling an error in the effective area for the airbag caused by differences in seating position or physique of occupants.

### BRIEF DESCRIPTION OF THE DRAWINGS

FIG. 1 is a view showing a device configuration of a vehicle seat control device of an embodiment.

FIG. 2 is a view showing a movement range of a vehicle seat.

FIG. 3 is a block diagram showing a configuration of the vehicle seat control device.

FIG. 4 is a view for describing protection of an occupant seated on the vehicle seat.

FIG. 5 is a flowchart showing a flow of processing of the vehicle seat control device.

FIG. 6 is a modified example of a flowchart showing a flow of processing of the vehicle seat control device.

FIG. 7 is a configuration diagram in a case that the vehicle seat control device is applied to an automated driving vehicle.

### DESCRIPTION OF EMBODIMENTS

Hereinafter, an embodiment of a vehicle seat control device, a vehicle seat control method, and a storage medium of the present invention will be described with reference to the drawings.

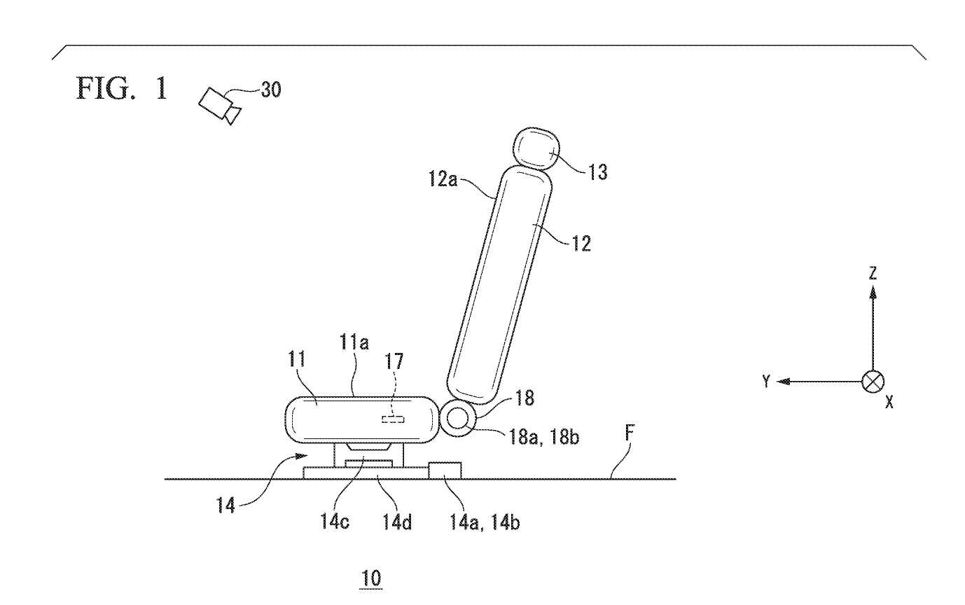

FIG. 1 is a view showing a device configuration of a vehicle seat control device 1 of the embodiment. A vehicle seat 10 on which an occupant sits is one or both of a front seat and a back seat. The vehicle seat 10 is a so-called power seat in which a position thereof in a front-rear direction and a reclining angle thereof are able to be electrically adjusted. The vehicle seat 10 is provided to be movable with respect to a floor surface F. Above the vehicle seat 10, a camera device (a seating position detection unit) 30 for imaging an occupant D and the vehicle seat 10 is provided.

A vehicle on which the vehicle seat control device 1 is mounted is, for example, a vehicle such as a two-wheeled vehicle, a three-wheeled vehicle, or a four-wheeled vehicle, and a driving source thereof is an internal combustion engine such as a diesel engine or a gasoline engine, an electric motor, or a combination thereof. The electric motor operates using electric power generated by a generator connected to an internal combustion engine, or discharge power of a secondary battery or a fuel cell.

The vehicle seat 10 includes, for example, a seat portion 11 and a backrest portion 12. In the vehicle seat 10, one end of the seat portion 11 and a lower end of the backrest portion 12 are rotatably connected by a first connecting portion 18. At an upper end of the backrest portion 12, a headrest 13 is provided.

The seat portion 11 is a member that supports a lower body of an occupant. A seating surface 11a on which the occupant D is seated is formed on the seat portion 11. The seating surface 11a is formed of a cushioning material. The seat portion 11 is attached to the floor surface F via a sliding portion 14.

The sliding portion 14 includes a first driving unit 14a, a seat position detection unit 14b, a pair of seat pedestals 14c, and a pair of seat rails 14d. Upper ends of the pair of seat pedestals 14c are fixed to a lower surface of the seat portion. The pair of seat rails 14d are disposed parallel to the floor surface F in a front-rear direction (Y axis direction) of the vehicle.

Lower ends of the pair of seat pedestals 14c slide in the front-rear direction of the vehicle along the pair of seat rails 14d. Thereby, the vehicle seat 10 is slidable in the front-rear direction of the vehicle. The pair of seat pedestals 14c are driven by the first driving unit 14a. The seat position detection unit 14b is provided in the first driving unit 14a. The seat position detection unit 14b detects a position of the seat pedestals 14c.

The first driving unit 14a operates in a case that the occupant D operates a switch 17. When the occupant D performs a predetermined operation with the switch 17, the pair of seat pedestals 14c slide along the pair of seat rails 14d in the front-rear direction of the vehicle. The first driving unit 14a and the seat position detection unit 14b are connected to a control unit 80 as will be described below, and movement of the vehicle seat 10 is controlled by the control unit 80.

The backrest portion 12 is a member for supporting a torso portion of the occupant. A backrest surface 12a is formed on the backrest portion 12. The backrest surface 12a is formed of a cushioning material. The headrest 13 is provided at a distal end of the backrest portion 12. The headrest 13 supports a head portion or a neck portion of the occupant seated on the seat portion 11. The backrest portion 12 can be brought into a reclining state in which a rotation angle is imparted with respect to the floor surface F by the first connecting portion 18. The first connecting portion 18 includes a second driving unit 18a and a seat angle detection unit 18b.

The second driving unit 18a operates in a case that the occupant D operates the switch 17. When the occupant D performs a predetermined operation with the switch 17, the second driving unit 18a rotates the backrest portion 12 in a direction (+Y direction) in which an angle formed by the backrest portion 12 and the seat portion 11 is narrowed.

When the occupant D performs another operation with the switch 17, the backrest portion 12 rotates backward (−Y direction) around the first connecting portion 18 and the angle formed by the backrest portion 12 and the seat portion 11 widens. A seat angle detection unit 18b is provided in the second driving unit 18a. The seat angle detection unit 18b detects the angle formed by the backrest portion 12 and the seat portion 11. The second driving unit 18a and the seat angle detection unit 18b are connected to the control unit 80 as will be described below, and the reclining angle is controlled by the control unit 80.

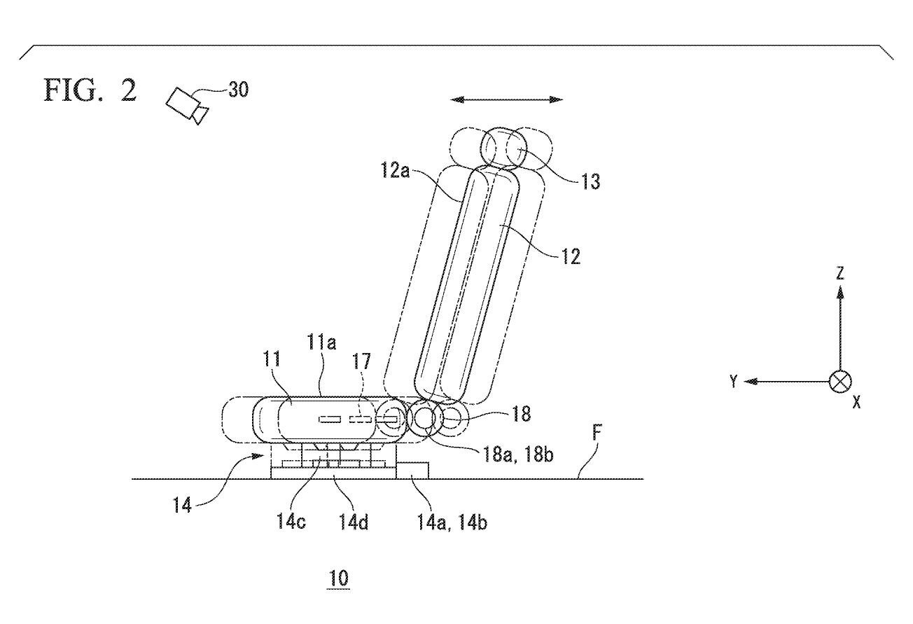

FIG. 2 is a view showing a movement range of the vehicle seat 10. As illustrated in the drawing, the vehicle seat 10 is movable in the front-rear direction along the pair of seat rails 14d. The camera device 30 images the inside of the vehicle. The camera device 30 includes a digital camera utilizing a solid-state image sensing device such as a charge coupled device (CCD) or a complementary metal oxide semiconductor (CMOS), for example, and detects the occupant D or the backrest portion 12. The camera device 30 may be, for example, a distance camera that measures a distance on the basis of a captured image. One or more camera devices 30 can be mounted inside the vehicle which is so equipped. The camera device 30 may be attached to a ceiling, an interior mirror, or the like, for example.

The camera device 30 detects a seating position of the occupant D relative to the backrest portion 12 on the basis of a captured image in a state in which the occupant D is seated on the vehicle seat 10. The control unit 80 is connected to the camera device 30 as will be described below, and outputs information on the seating position of the occupant D.

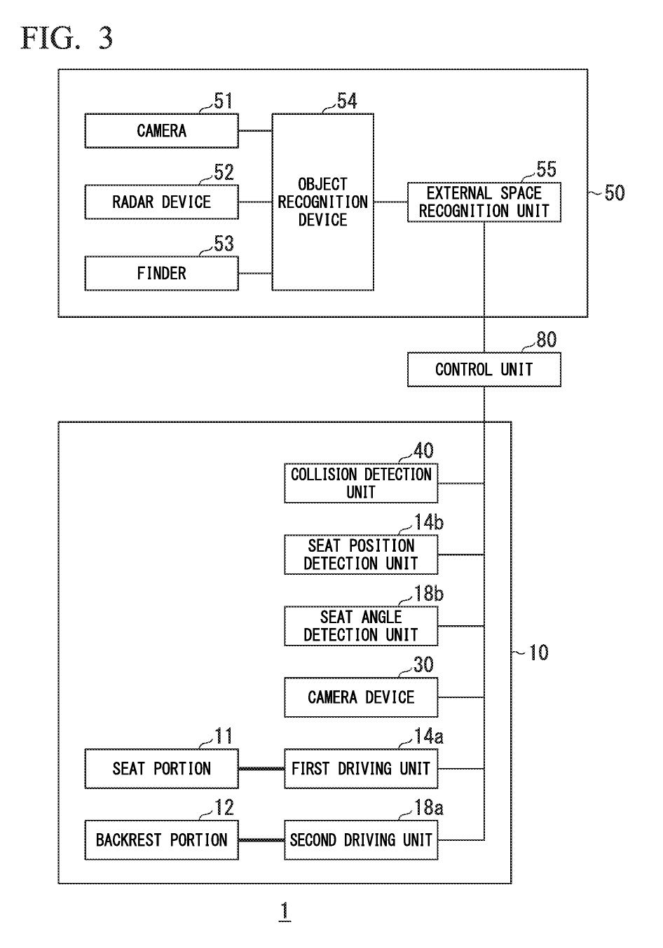

FIG. 3 is a block diagram showing a configuration of the vehicle seat control device 1. The vehicle seat control device 1 includes the vehicle seat 10, a collision prediction unit 50, and the control unit 80. Hereinafter, a configuration of the collision prediction unit 50 will be described. The collision prediction unit 50 includes, for example, a camera 51, a radar device 52, a finder 53, an object recognition device 54, and an external space recognition unit 55. The collision prediction unit 50 predicts in advance whether a collision will occur in a vehicle on the basis of a state of the surroundings of the vehicle.

The external space recognition unit 55 and the control unit 80 are each realized by a processor such as a central processing unit (CPU) executing a program (software). Some or all of functional units of the control unit 80 to be described below may be realized by hardware such as a large scale integration (LSI), an application specific integrated circuit (ASIC), a field-programmable gate array (FPGA), or may be realized by cooperation of software and hardware. Programs may be stored in advance in a storage device such as a hard disk drive (HDD) or a flash memory, or may be stored in a detachable storage medium such as a DVD or a CD-ROM and then installed in a storage device in a case that the storage medium is mounted on a drive device.

The camera 51 is, for example, a digital camera utilizing a solid-state image sensing device such as a CCD or a CMOS. One or more cameras 51 can be attached to arbitrary places on a vehicle which is so equipped. When a side in front is imaged, the camera 51 can be attached to an upper portion of a front windshield, a rear surface of an interior mirror, or the like. When rear behind is imaged, the camera 51 can be attached to an upper portion of a rear windshield, a rear door, or the like. When a lateral side is imaged, the camera 51 can be attached to a door mirror or the like. For example, the camera 51 may periodically repeat imaging of the surroundings of the vehicle. The camera 51 may be a stereo camera.

The radar device 52 radiates radio waves such as millimeter waves and the like around a vehicle, and detects at least a position (distance to and bearings) of an object by detecting radio waves (reflected waves) reflected by the object. The radar device 52 can be attached to one arbitrary location on the vehicle. Alternatively, a plurality of radar devices 52 can be attached to an arbitrary plurality of locations on the vehicle. The radar device 52 may detect a position and a speed of an object by a frequency modulated continuous wave (FMCW) method.

The finder 53 is a light detection and ranging (LIDAR) or laser imaging detection and ranging (LIDAR) that measures scattered light with respect to irradiated light and detects a distance to an object. The finder 53 can be attached to one arbitrary location on the vehicle. Alternatively, a plurality of finders 53 can be attached to a plurality of locations.

The object recognition device 54 performs sensor fusion processing on detection results from some or all of the camera 51, the radar device 52, and the finder 53 and recognizes a position, a type, a speed, and the like of the object. The object recognition device 54 outputs the recognition results to the external space recognition unit 55.

On the basis of information input from the camera 51, the radar device 52, and the finder 53 via the object recognition device 54, the external space recognition unit 55 recognizes states of a nearby vehicle such as a position, a speed, and an acceleration. A position of a nearby vehicle may be indicated by representative points such as a center of gravity or corners of the nearby vehicle, or may be indicated by a region expressing an outline of the nearby vehicle. The “state” of the nearby vehicle may include an acceleration or a jerk of the nearby vehicle, or a “behavior state” (for example, whether or not lane change is being performed, or a lane change is being attempted).

In addition to a nearby vehicle, the external space recognition unit 55 may recognize positions of guard rails, utility poles, parked vehicles, persons such as pedestrians, or other objects. Thereby, the external space recognition unit 55 recognizes a state of the surroundings of the vehicle and predicts a state in which an acceleration caused by a collision or the like is applied to the vehicle. At this time, the external space recognition unit 55 predicts a collision direction of the vehicle and a time before a collision will occur on the basis of, for example, temporal differences in recognized information. The time before a collision against an object occurs is derived, for example, by a time to collision (TTC) which is a ratio of a relative distance to the object to a relative speed to the object.

In addition to the collision direction of the vehicle or the like, the external space recognition unit 55 may also predict a type of collision occurring in the vehicle. The mode of collision, for example, may be one in which types of a collision object such as a vehicle versus a vehicle, a collision state of the vehicle such as rotation of the vehicle, a collision speed of the vehicle, and a categorization of vehicle collision differences such as a time before collision occurs, are defined.

When it is predicted that a predetermined acceleration or more will be applied to the vehicle in a collision direction due to a collision or the like, the external space recognition unit 55 outputs the prediction result to the control unit 80. For example, the external space recognition unit 55 predicts that an acceleration of a predetermined value or more is applied in a collision direction depending on whether or not it exceeds a preset threshold value.

Hereinafter, a configuration of the vehicle seat 10 will be described. The vehicle seat 10 includes a collision detection unit 40, the seat position detection unit 14b, the seat angle detection unit 18b, the camera device 30, the first driving unit 14a, and the second driving unit 18a.

The collision detection unit 40 is, for example, an acceleration sensor. The collision detection unit 40 detects an acceleration generated in the vehicle seat 10. A collision occurring in the vehicle is detected by the collision detection unit 40. As shown in the figure, the collision detection unit 40 may be provided, for example, in the vehicle seat 10. The collision detection unit 40 may be provided at a location other than the vehicle seat 10 as long as an acceleration generated in the vehicle can be detected. The collision detection unit 40 may be shared with a sensor of an airbag B. The collision detection unit 40 outputs detection results to the control unit 80.

The first driving unit 14a changes a position of the seat portion 11. The first driving unit 14a is controlled by the control unit 80. The seat position detection unit 14b detects a position of the seat portion 11 and outputs detection results to the control unit 80.

The second driving unit 18a changes a posture of the backrest portion 12. The seat angle detection unit 18b detects a posture angle of the backrest portion 12 and outputs detection results to the control unit 80.

With the above configuration, the control unit 80 controls the first driving unit 14a or the second driving unit 18a such that the position or posture of the vehicle seat 10 is changed on the basis of the prediction result of the external space recognition unit 55 of the collision prediction unit 50 and the detection results of the camera device 30, the seat position detection unit 14b, and the seat angle detection unit 18b.

Hereinafter, control of the vehicle seat 10 by the control unit 80 in a case that occurrence of collision in the vehicle is predicted will be described.

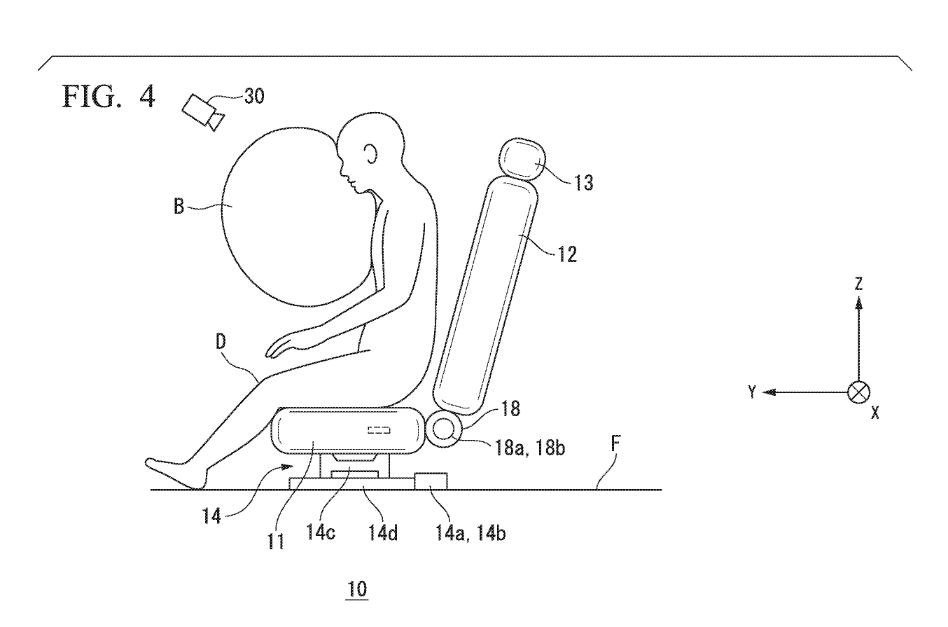

FIG. 4 is a view for describing protection of the occupant D seated on the vehicle seat 10. When a collision occurs in the vehicle, the airbag B is deployed to protect the occupant D. The airbag B protects the head of the occupant D in a case that a collision occurs.

An effective area capable of protecting the occupant D in a state in which the airbag B is deployed is designed on the premise that a position of the vehicle seat 10 in the front-rear direction of the vehicle is within a predetermined range, a reclining angle is, for example, within a predetermined angular range used during manual control, and further, a posture of the occupant is a posture that is effectively protected by a seat belt. This state is referred to as a standard state.

When a state of the vehicle seat 10 before occurrence of a collision is a state different from the standard state, it is necessary to sufficiently protect the occupant D with the airbag B.

For example, in a case that the vehicle seat 10 has been moved rearward by an operation of the occupant D or in a case that the backrest portion 12 has been reclined rearward, it is necessary to cause the occupant D to reach an effective area for the airbag B to sufficiently protect the occupant with the seatbelt. Even in a case that the vehicle seat 10 is in a position of the standard state, it is necessary to cause the airbag B to reach the effective area in consideration of a difference in physique of the occupant D.

In addition to, for example, a case in which the vehicle seat 10 has been moved forward by an operation of the occupant D or a case in which a seating position of the seat portion 11 of the occupant D is close to the front side, it is necessary to adjust a physical load on the occupant D of the inflated airbag B in consideration of difference in the physique of the occupant D.

Therefore, the control unit 80 controls the first driving unit 14a or the second driving unit 18a to bring the vehicle seat 10 closer to a target state during the time before a collision predicted by the external space recognition unit 55 occurs.

Here, the target state is based on the above-described standard state of the vehicle seat 10. The target state is determined, for example, using the following conditions.

(1) A position of the vehicle seat 10 in the front-rear direction of the vehicle is within a predetermined range, and a reclining angle of the vehicle seat 10 is within a predetermined angular range used during manual control.

(2) A state of the vehicle seat 10 in which the head of the occupant D is in the effective area for the airbag B.

(3) A state of the vehicle seat 10 in which a posture of the occupant D is effectively protected by the seat belt.

That is, during the time before a collision predicted by the external space recognition unit 55 occurs, the control unit 80 controls the first driving unit 14a or the second driving unit 18a such that a position or posture of the vehicle seat 10 is changed on the basis of detection results of the seat position detection unit 14b and the seat angle detection unit 18b. Thereby, the vehicle seat control device 1 can move the vehicle seat 10 to the designed effective area for the airbag B.

The control unit 80 further moves the vehicle seat 10 to the effective area for the airbag B on the basis of a seating position of the occupant D relative to the backrest portion 12 detected by the camera device 30. Thereby, the vehicle seat control device 1 reconciles variations according to a physique or seating position of the occupant D, moves the vehicle seat 10 to the actual effective area for the airbag B, and thus can bring the vehicle seat 10 close to the target state.

During the time before the predicted collision occurs, in a case that a collision is detected by the collision detection unit 40 while the control unit 80 controls the first driving unit 14a or the second driving unit 18a, the control unit 80 may stop controlling the first driving unit 14a or the second driving unit 18a. Thereby, the vehicle seat control device 1 can prevent an electrical load from becoming overloaded due to the collision even in a case that a collision occurs earlier than the time before a predicted collision occurs.

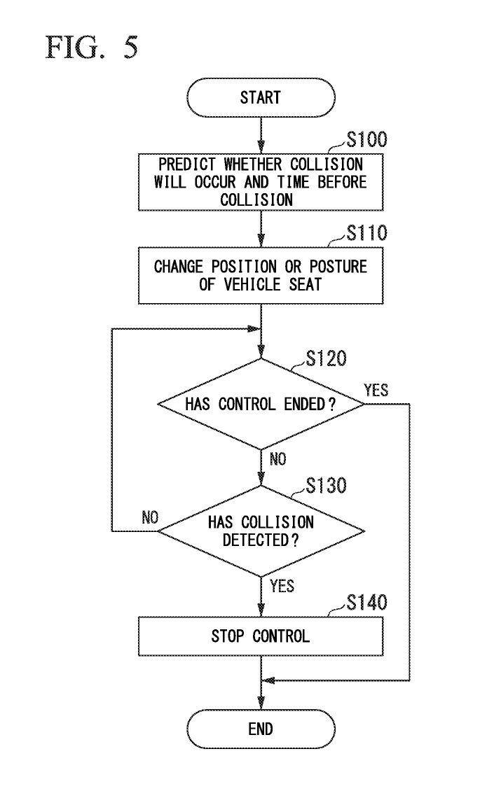

Hereinafter, processing of the vehicle seat control device 1 will be described. FIG. 5 is a flowchart showing an example of a flow of processing of the vehicle seat control device 1.

The external space recognition unit 55 predicts whether a collision will occur in the vehicle and a time before the collision will occur (step S100). During the time before the collision predicted by the external space recognition unit 55 occurs, the first driving unit 14a or the second driving unit 18a is controlled on the basis of detection results of the seat position detection unit 14b, the seat angle detection unit 18b, and the camera device 30 so that a position or posture of the vehicle seat 10 is changed to bring the vehicle seat 10 close to the target state (step S110).

During the time before the collision occurs, in a case that a collision is detected by the collision detection unit 40 (step S130) while the control unit 80 changes a position or posture of the vehicle seat 10 (step S120), the control unit 80 stops controlling the first driving unit 14a or the second driving unit 18a (step S140).

### Modified Example

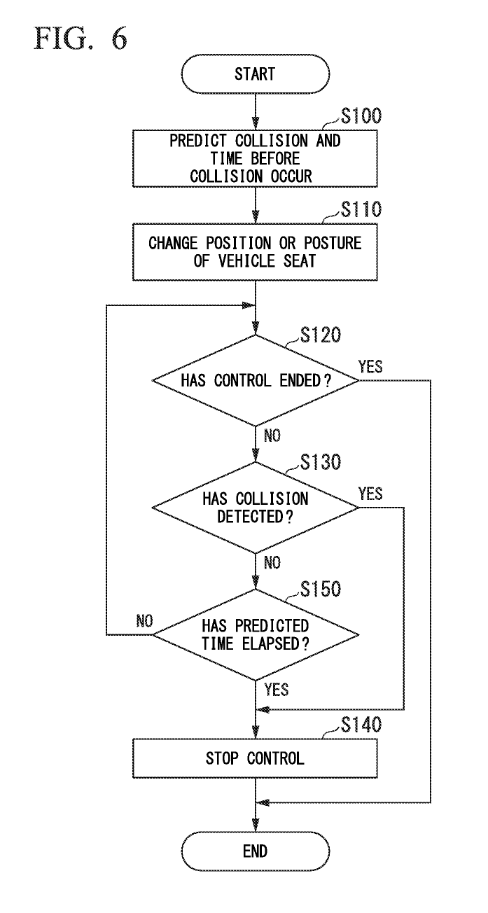

FIG. 6 is a modified example of a flowchart showing a flow of processing of the vehicle seat control device 1. Here, step S150 is added as a loop in a case that no collision is detected by the collision detection unit 40 in step S130 of FIG. 5. When a negative determination is obtained in step S130, the control unit 80 determines whether or not the time before the predicted collision occurs has elapsed (step S150), and in a case that it is determined that the time has elapsed, the control unit 80 stops controlling the first driving unit 14a or the second driving unit 18a (step S140).

Thereby, the vehicle seat control device 1 can prevent an electrical load caused by the collision from becoming overloaded even in a case that the collision occurs at a later stage than the time before the predicted collision occurs.

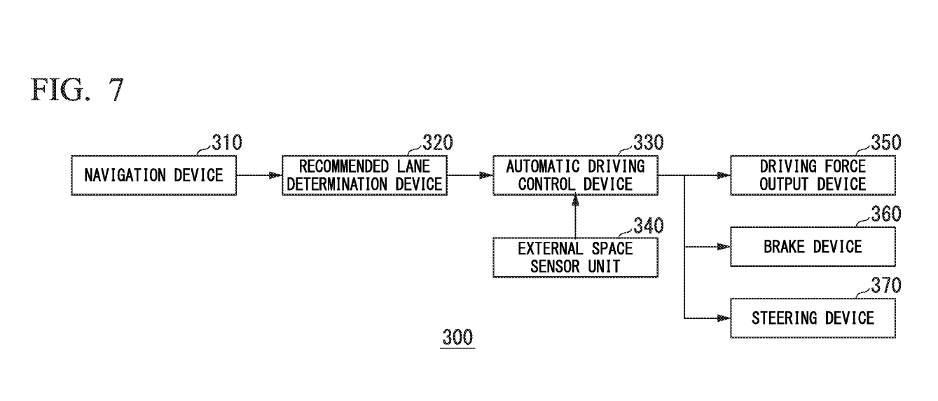

The vehicle seat control device 1 described above may also be applied to an automated driving vehicle 300. FIG. 7 is a configuration diagram in a case that the vehicle seat control device 1 is applied to the automated driving vehicle 300. A navigation device 310 outputs a route to a destination to a recommended lane determination device 320. The recommended lane determination device 320 refers to a map which is more detailed than map data provided in the navigation device 310, determines a recommended lane in which the vehicle should travel, and outputs the determined recommended lane to an automated driving control device 330. The automated driving control device 330 may include the above-described vehicle seat control device 1 or may be a separate body therefrom.

On the basis of information input from an external space sensor unit 340 including a camera or a radar device, a LIDAR, an object recognition device, and the like, the automated driving control device 330 controls some or all of a driving force output device 350 including an engine or a motor, a brake device 360, and a steering device 370 to travel along the recommended lane input from the recommended lane determination device 320.

In such an automated driving vehicle 300, it is conceivable that an occupant boards and is able to sit freely in contrast to a manual driving vehicle. Therefore, in response to an unexpected collision, it is necessary to effectively protect occupants by occupant protection devices such as an existing airbag. When the vehicle seat control device 1 of the present embodiment is used, the protection performance for the occupant D can be enhanced.

According to the vehicle seat control device 1 of the above-described embodiment, in a case that a collision occurring in the vehicle and a time before the collision occurs are predicted, it is possible to enhance the protection performance for the occupant D by bringing the vehicle seat 10 close to the target state during the time before the collision occurs. According to the vehicle seat control device 1, since the vehicle seat 10 is controlled on the basis of detection results of the seat position detection unit 14b and the seat angle detection unit 18b, the vehicle seat 10 can be moved to the designed effective area for the airbag B.

According to the vehicle seat control device 1, since the vehicle seat 10 is controlled on the basis of detection results of the camera device 30, variations depending on a physique of the occupant D and a seating position can be adjusted and the vehicle seat 10 can be moved to the actual effective area for the airbag B.

Although embodiments for implementing the present invention have been described above, the present invention is not limited to these embodiments at all, and various modifications and substitutions can be added within the scope of the present invention without departing from the spirit of the present invention.

What is claimed is:

1. A vehicle seat control device comprising:
a collision prediction unit which predicts whether a collision will occur in a vehicle and a time before the collision will occur;
a driving unit which changes at least one of a position and a posture of a vehicle seat; and
a control unit which controls the driving unit such that the vehicle seat is brought close to a target state during the time before the collision predicted by the collision prediction unit occurs.

2. The vehicle seat control device according to claim 1, wherein the target state is a state in which:
a position of the vehicle seat in a front-rear direction of the vehicle is within a predetermined range; and
a reclining angle is within a predetermined angular range used during manual control.

3. The vehicle seat control device according to claim 1, wherein the target state is a state of the vehicle seat in which a head of an occupant is in an effective area for an airbag.

4. The vehicle seat control device according to claim 1, wherein the target state is a state of the vehicle seat having a posture in which an occupant has a posture allowing effective protection by a seat belt.

5. The vehicle seat control device according to claim 1, wherein the collision prediction unit predicts a time before the collision with respect to an object will occur on the basis of a relative distance between the vehicle and the object and a relative speed between the vehicle and the object.

6. The vehicle seat control device according to claim 1, further comprising a collision detection unit which detects a collision, wherein the control unit stops controlling the driving unit in a case that a collision is detected by the collision detection unit.

7. The vehicle seat control device according to claim 1, further comprising a seating position detection unit which detects a seating position of an occupant relative to a backrest portion, wherein the control unit moves the vehicle seat to an effective area for an airbag on the basis of the seating position detected by the seating position detection unit.

8. A seat control method using an in-vehicle computer, comprising:
predicting whether a collision will occur in a vehicle and a time before the collision will occur;
changing a position or a posture of the vehicle seat; and
bringing the vehicle seat close to a target state during the time before the predicted collision occurs.

9. A non-transitory computer-readable recording medium recording a seat control program causing an in-vehicle computer to:
predict whether a collision will occur in a vehicle and a time before the collision will occur;
change a position or a posture of a vehicle seat; and
bring the vehicle seat close to a target state during the time before the predicted collision occurs.
